(19) United States
(12) Patent Application Publication
(10) Pub. No.: US 2025/0312726 A1
(43) Pub. Date: Oct. 9, 2025

(54) A PROCESS FOR CAPTURE OF CARBON DIOXIDE

(71) Applicant: SHELL USA, INC., Houston, TX (US)

(72) Inventors: Sayee Prasaad BALAJI, Amsterdam (NL); Timothy Michael NISBET, Amsterdam (NL); Charles Duncan BRODIE, Boston, MA (US)

(21) Appl. No.: 18/865,211

(22) PCT Filed: May 9, 2023
(86) PCT No.: PCT/EP2023/062200

§ 371 Date: Nov. 12, 2024

(30) Foreign Application Priority Data
May 13, 2022 (EP) 22173322.3

(51) Int. Cl. B01D 53/04

(52) U.S. Cl. CPC B01D 53/0446; B01D 53/0454; B01D 2253/342; B01D 2257/504; B01D 2258/06; B01D 2259/40086

(57) ABSTRACT

A process for capture of CO₂ from a gaseous CO₂-containing stream. The process comprises (a) providing stream; (b) passing the stream through a plurality of adjacent porous monolith sorbent blocks. Each block defines internal channels from a first side of block that can receive the stream to a second side from which a treated gaseous stream having a reduced CO₂-concentration can exit. The method further comprises (c) removing treated stream; (d) sealing the first and second sides of a block upon reaching a pre-determined CO₂ saturation level, to obtain a partly sealed block; (e) desorbing the partly sealed block using a desorption fluid to obtain a CO₂-enriched stream and a partly sealed CO₂-depleted block; (f) removing the stream; (g) unsealing the first and second sides; and (h) recommencing passing the stream through the unsealed CO₂-depleted block.

The present invention relates to a process and system for the capture of carbon dioxide (CO₂) from a gaseous CO₂-containing stream such as air or from a specially conditioned atmosphere such as one that includes exhaust flue gases from industrial processes.

Direct air capture (DAC) of carbon dioxide from the air has been proposed as one way of addressing human induced climate change. Current estimates place global levels of CO₂ in the atmosphere at around 420 parts per million. This is expected to rise to around 900 parts per million by the end of the 21^{st} century. Hence, DAC represents one of a range of technologies that can be employed to reduce the environmental impact of greenhouse gases like CO₂ and help the transition to a low carbon global economy.

Typical DAC systems take large quantities of air (or other conditioned gaseous atmosphere) which is pumped as a (feed) stream through a unit that contains a sorbent substance that removes the CO₂ from the stream under ambient conditions. Over time the sorbent becomes loaded with captured CO₂. Next, the captured CO₂ in the sorbent is extracted from the sorbent in a regeneration/desorption step. Desorption may involve thermal or chemical processes depending upon the type of sorbent material that is selected for use in the DAC. For example, amine-functionalised resins such as polyethyleneimines (PEI) can serve as effective sorbents that are regenerated with steam at temperatures of above 50° C., typically up to or around 130° C. Upon regeneration the captured CO₂ is released from the sorbent and can be used to manufacture sustainable fuels, specialty chemicals, in food and beverage production or in carbon capture and sequestration (CCS) in order to create a net negative carbon process.

Several publications on DAC systems have been made in the recent past.

A problem of known DAC systems is the occurrence of contamination with air of the captured CO₂ in the desorption step. DAC is a capital-intensive process due to the necessity to process large amount of air. The air is typically moved by fans and the energy consumption is proportional to the pressure drop. Any pressure drop above a few mbar will lead to very high energy cost.

EP 3 725 391 B1 proposes a separation unit for separating carbon dioxide from ambient air, wherein the separation unit comprises at least one contiguous and sealing circumferential wall element, circumferentially enclosing at least one cavity. The at least one contiguous and sealing circumferential wall element defines an upstream opening and an opposed downstream opening of the at least one cavity. The cavity contains at least one gas adsorption structure for adsorbing carbon dioxide. The separation unit further comprises a pair of opposing sliding doors for sealing the upstream opening and the downstream opening of at least one cavity in a closed state.

A problem of the system as proposed in EP 3 725 391 B1 is the associated costs of the measures needed to fully seal the cavity in a closed state.

Another problem is the additional weight of the sealing circumferential wall elements, which require stronger structural elements for the separation unit.

A further problem is the difficulty of removing and replacing sorbent from within the cavities, when sorbent replacement is needed.

It is an object of the present invention to solve, minimize or at least reduce one or more of the above problems.

It is a further object of the present invention to provide an alternative system and process for the capture of CO₂ from a CO₂-containing gas stream, whilst achieving a low-pressure drop and a reduced contamination with air of the captured CO₂ in the desorption step.

One or more of the above or other objects may be achieved by the present invention by providing a process for capture of carbon dioxide (CO₂) from a gaseous CO₂-containing stream, the process at least comprising the steps of:
(a) providing a gaseous CO₂-containing stream, in particular ambient air;
(b) passing the gaseous CO₂-containing stream through a plurality of adjacent porous monolith sorbent blocks thereby adsorbing CO₂ from the CO₂-containing stream onto the monolith sorbent blocks, wherein each of the monolith sorbent blocks defines substantially parallel internal channels from a first side of the monolith sorbent block that during a CO₂-adsorption phase can receive the gaseous CO₂-containing stream to a second side from which a treated gaseous stream having a reduced CO₂-concentration can exit the monolith sorbent block;
(c) removing a treated stream from the second side of the monolith sorbent blocks having a reduced CO₂-concentration compared to the gaseous CO₂-containing stream provided in step (a);
(d) sealing the first and second sides of a monolith sorbent block once it has reached a pre-determined CO₂ saturation level, wherein during the sealing of the first and second sides of the monolith sorbent block the remainder of the monolith sorbent block is not fully sealed thereby obtaining a partly sealed monolith sorbent block;
(e) desorbing the partly sealed monolith sorbent block by passing a stream of a desorption fluid through the partly sealed monolith sorbent block thereby releasing CO₂ adsorbed to the partly sealed monolith sorbent block and thereby obtaining a CO₂-enriched stream and a partly sealed CO₂-depleted monolith sorbent block;
(f) removing the CO₂-enriched stream obtained in step (e) from the partly sealed monolith sorbent block;
(g) undoing the sealing of the first and second sides of the partly sealed CO₂-depleted monolith sorbent block thereby obtaining an unsealed CO₂-depleted monolith sorbent block; and
(h) recommencing the passing of gaseous CO₂-containing stream through the unsealed CO₂-depleted monolith sorbent block obtained in step (g).

It has been surprisingly found according to the present invention that by using monolith sorbent blocks (rather than sorbent beds), a low-pressure drop and a reduced contamination with air can be achieved for the captured CO₂ in a desorption step without the need of full sealing as required in for example EP 3 725 391 B1. In this respect it is noted that EP 3 725 391 B1 does not mention the use of monolith sorbent blocks.

A further advantage of the present invention is that
as surprisingly no full sealing is required-fewer components are needed, whilst still allowing for easy operation, efficient CO₂ capture and high reliability under long term use.

Another advantage of the present invention is that the monolith sorbent blocks can be easily removed from the separation unit, for example by hoisting, which facilitates replacement of the monolith sorbent blocks.

Furthermore, velocities for the desorption fluid of below 0.5 m/s can be used whilst avoiding significant contamination of the obtained CO₂-enriched stream with air.

In step (a) of the process according to the present invention, a gaseous CO₂-containing stream, in particular ambient air, is provided. The CO₂-containing stream is not particularly limited and will typically have a relatively low CO₂-concentration (of between 300 ppmv-2 vol. % CO₂). Generally, the CO₂-containing stream will be ambient air.

In step (b) of the process according to the present invention, the gaseous CO₂-containing stream is passed through a plurality of adjacent porous monolith sorbent blocks thereby adsorbing CO₂ from the CO₂-containing stream onto the monolith sorbent blocks, wherein each of the monolith sorbent blocks defines substantially parallel internal channels from a first side of the monolith sorbent block that during a CO₂-adsorption phase can receive the gaseous CO₂-containing stream to a second side from which a treated gaseous stream having a reduced CO₂-concentration can exit the monolith sorbent block.

As monolith sorbent blocks are known in the art as such, these will not be discussed here in detail.

Monolith technology has for example been described in the article by T. Boger et al., Monolithic Catalysts for the Chemical Industry, Ind. Eng. Chem. Res. 2004, 43, 4602-4611 and T. A. Nijhuis et al., Preparation of monolithic catalysts, Catalysis Reviews, 43 (4), 345-380, 2001.

Porous monolith sorbent blocks suitable for use in the present invention will typically have between 50 and 400 cells per square inch (CPSI), preferably between 100 and 200 CPSI.

The depth of the porous monolith sorbent blocks between the first and second sides will typically be between 0.1 and 1.0 m, preferably between 0.015 and 0.5 m.

The surface area of the first side of the porous monolith sorbent block will typically be between 1 m² and 5 m². The porous monolith sorbent block may comprise a collection of sorbent bricks of smaller dimensions. The plurality of adjacent porous monolith sorbent blocks will typically have a total surface area for the first sides of between 6 m² and 30 m².

In an especially preferred embodiment according to the present invention, the plurality of adjacent porous monolith sorbent blocks has a total surface area for the first sides of between 15 m² and 25 m², whilst the porous monolith sorbent blocks are installed in a housing with the dimensions of a standard 40 ft sea container.

As mentioned above, each of the monolith sorbent blocks defines substantially parallel internal channels from a first side of the monolith sorbent block that during a CO₂-adsorption phase can receive the gaseous CO₂-containing stream to a second side from which a treated gaseous stream having a reduced CO₂-concentration can exit the monolith sorbent block.

Typically, each monolith sorbent block is formed of a highly porous substrate, such as an alumina or silica, having a high proportion of a sorbent such as an inorganic carbonate or an amine on its available surfaces to facilitate CO₂ adsorption.

Preferably, the plurality of adjacent porous monolith sorbent blocks have a gas permeability (preferably between 10⁻⁶ and 10⁻⁸ m², more preferably between 5×10⁻⁶ and 5×10⁻⁷ m²) that is higher in the direction of the substantially parallel internal channels from the first side to the second sides thereof than in the direction perpendicular to the parallel internal channels (preferably between 10⁻¹⁰ and 10⁻¹⁴ m²).

It will be appreciated that very large amounts of gas (e.g. ambient air) need to be passed through the monolith sorbent block to capture sufficient CO₂. To avoid excessive power consumption, it is also necessary to operate with low gas flow velocities, which typically limits velocity in the monolith sorbent blocks to below 10 m/s, more typically below 5 m/s. Preferably, the gaseous CO₂-containing stream being passed through the channels of the plurality of adjacent porous monolith sorbent blocks has a velocity of greater than 1.0 m/s. This, to process sufficient amounts of air to obtain a targeted CO₂ capture rate, whilst giving an acceptable pressure drop.

In step (c) of the process according to the present invention, a treated stream is removed from the second side of the monolith sorbent blocks having a reduced CO₂-concentration compared to the gaseous CO₂-containing stream provided in step (a). Typically, the treated stream has a CO₂-concentration of at most 250 ppmv CO₂, preferably at most 200 ppmv CO₂.

In step (d) of the process according to the present invention, the first and second sides of a monolith sorbent block are sealed once it has reached a pre-determined CO₂ saturation level, wherein during the sealing of the first and second sides of the monolith sorbent block the remainder of the monolith sorbent block is not fully sealed thereby obtaining a partly sealed monolith block.

The sealing according to the present invention is not particularly limited and can be performed in many ways. As a mere example, the sealing can take place whilst using a plate or the like, thereby closing off the first and second sides of a monolith sorbent block from receiving gaseous CO₂-containing stream. If desired, the first and second sides of multiple monolith sorbent block can be sealed at the same time.

An important aspect of the present invention is that during the sealing of the first and second sides of the monolith sorbent block the remainder of the monolith sorbent block is not fully sealed. Hence, the remainder of the monolith sorbent block being sealed is not in a fully closed or sealed chamber (as required in for example EP 3 725 391 B1).

Preferably, during sealing of a monolith sorbent block, the first and second sides of a monolith sorbent block are sealed in step (d) by moveable doors.

The person skilled in the art will readily understand that several levels of sealing can be applied, provided that the monolith sorbent block being sealed is not fully sealed, such as in a fully closed or sealed chamber. As a mere example, in addition to the first and second side also the top or bottom can be sealed during the sealing.

According to an especially preferred embodiment of the present invention, the moveable doors form part of a moveable gantry, wherein the doors of the moveable gantry only seal the first and second sides of a monolith sorbent block.

According to a further preferred embodiment, a space between two adjacent porous monolith sorbent blocks is left unsealed. In an even further preferred embodiment, the pressure in the porous monolith sorbent block is maintained during desorption at just below atmospheric pressure (preferably between 0.9-1.0 bara, more preferably between 0.95 and 1.00 bara) and a small portion (preferably less than 2.0 vol. %, more preferably less than 1.0 vol. %) of the desorption fluid or the obtained CO₂-enriched stream is introduced in this space.

According to the present invention, the timing of the sealing will typically be determined dependent on when the monolith sorbent block reaches a pre-determined CO₂ saturation level. This pre-determined CO₂ saturation level is not particularly limited and can for example be selected to be a certain percentage of full saturation (e.g. more than 30%, preferably more than 50%, more preferably more than 80%) or a certain absolute value (e.g. at least 0.2 mol/kg CO₂, preferably at least 0.4 mol/kg CO₂, more preferably at least 0.8 mol/kg CO₂).

In step (e) of the process according to the present invention, the partly sealed monolith sorbent block is desorbed by passing a stream of a desorption fluid through (in particular the channels of) the partly sealed monolith sorbent block thereby releasing CO₂ adsorbed to the partly sealed monolith sorbent block and thereby obtaining a CO₂-enriched stream and a partly sealed CO₂-depleted monolith sorbent block.

The person skilled in the art will readily understand that the desorbing in step (e) is not particularly limited and can be performed in many ways. Also, the desorption fluid is not particularly limited; however, preferably the desorption fluid comprises steam.

If steam is used as the desorption fluid, then it will typically have a temperature up to 130° C. Preferably, the stream of desorption fluid in step (e) has a pressure of between 0.50-1.50 bara, preferably between 0.90-1.10 bara, more preferably between 0.95-1.05 bara. By maintaining the pressure of the desorption fluid close to atmospheric pressure, the differential pressure across the seals is kept low, hence minimizing leakages.

Further, it is preferred that the desorption fluid being passed through the channels of the plurality of adjacent porous monolith sorbent blocks has a velocity of below 0.5 m/s.

As mentioned above, one problem of known DAC processes (where sorbent beds are used instead of monolith sorbent blocks as according to the present invention) is that air in the sorbent bed is mixed with desorbed CO₂ during desorption, leading to lower CO₂ purity for the CO₂-enriched stream. In WO 2021/239748 a solution to this problem is proposed, where during regeneration with steam the velocity of the steam flow through the unit is between 0.5 and 10 times the velocity of the air flow during the adsorption step, thus limiting mixing by dispersion.

When using a porous monolith sorbent block according to the present invention with typical properties as mentioned above, dispersion in the axis parallel to the flow is limited even at low velocities, allowing surprisingly low flow velocities of e.g. steam as the desorption fluid. This provides for an economic advantage compared to processes using a higher flow velocity.

Typically, to allow the desorption fluid to pass through the channels of the partly sealed monolith sorbent block, the seal may contain an opening or manifold or the like to enable supply of the desorption fluid. The seal may further be constructed so as to allow multiple flow passes in series for the desorption fluid through the partly sealed monolith block.

According to a particularly preferred embodiment of the present invention, the desorption fluid is, before passing through (the channels of) the partly sealed monolith sorbent block, reduced in pressure over a pressure reducer upstream of the monolith sorbent block and further reduced in pressure over a pressure reducer downstream of the monolith sorbent block, wherein at least one of the pressure reducers is a valve and wherein a predetermined pressure in the monolith sorbent block is maintained by a controller acting on the at least one valve. The other pressure reducer may—if not also a valve—for example be an orifice or the like.

In step (f) of the process according to the present invention, the CO₂-enriched stream obtained in step (e) is removed from the partly sealed monolith sorbent block. Typically, the CO₂-enriched stream has a CO₂ concentration of at least 90 vol. %. The person skilled in the art will readily understand that the CO₂-enriched stream can be used for many purposes, such as subsurface storage, conversion into products, etc.

In step (g) of the process according to the present invention, the sealing of the first and second sides of the partly sealed CO₂-depleted monolith sorbent block is undone thereby obtaining an unsealed CO₂-depleted monolith sorbent block.

Then, in step (h) of the process according to the present invention, the passing of gaseous CO₂-containing stream through the unsealed CO₂-depleted monolith sorbent block obtained in step (g) is recommenced.

The person skilled in the art will readily understand that the adsorption/desorption sequence of steps (a)-(h) can be made cyclic and that the steps can be repeated multiple times.

Also, the person skilled in the art will understand that the monolith sorbent blocks can be desorbed one-by-one or that several adjacent sorbent blocks can be desorbed at the same time.

In a further aspect the present invention provides a system for capture of carbon dioxide (CO₂) from a gaseous CO₂-containing stream, the system at least comprising:
a plurality of adjacent porous monolith sorbent blocks, wherein each of the monolith sorbent blocks defines substantially parallel internal channels from a first side of the monolith sorbent block that during a CO₂-adsorption phase can receive the gaseous CO₂-containing stream to a second side from which a treated gaseous stream having a reduced CO₂-concentration can exit the monolith sorbent block; and
a sealer for sealing the first and second sides of a monolith sorbent block;
wherein during the sealing of the first and second sides of the monolith sorbent block the remainder of the monolith sorbent block is not fully sealed thereby obtaining a partly sealed monolith block.

Typically, to allow a desorption fluid to pass through the channels of the partly sealed monolith sorbent block during a desorption phase, the sealer may contain an opening or manifold or the like to enable supply of the desorption fluid.

According to a preferred embodiment of the system, the system further comprises moveable doors which can seal the first and second sides of a monolith sorbent block during a desorption phase. Preferably, the moveable doors form part of a moveable gantry, wherein the doors of the moveable gantry can seal only the first and second sides of a monolith sorbent block.

According to an especially preferred embodiment of the system, the sealer can leave a space between two adjacent monolith sorbent blocks unsealed during a desorption phase.

Further it is preferred that the system further comprises:
an upstream pressure reducer which can reduce the pressure of a desorption fluid before being passed through (the channels of) a partly sealed monolith sorbent block;
a downstream pressure reducer which can reduce the pressure of a desorption fluid downstream of the monolith sorbent block; and
a pressure controller which can act on at least one of the upstream and downstream pressure reducers to maintain a predetermined pressure in the monolith sorbent block. Typically, at least one (and preferably both) of the upstream and downstream pressure reducers is a valve. The other pressure reducer may—if not also a valve—for example be an orifice or the like.

According to a further preferred embodiment of the system according to the present invention, the system further comprises a filter placed upstream of the plurality of monolith sorbent blocks (when in CO₂ adsorption phase). Typically, the filter can filter out particles having a size of at least 0.5 mm and above which might otherwise foul the monolith sorbent blocks.

Hereinafter the present invention will be further illustrated by the following non-limiting drawings. Herein shows:

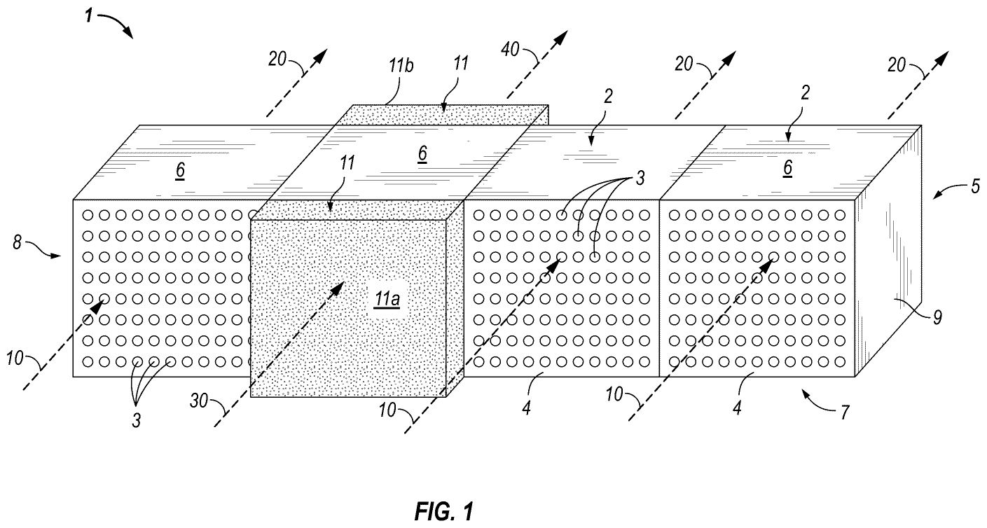

FIG. 1 a schematic representation of a DAC system according to the present invention in a first position; and

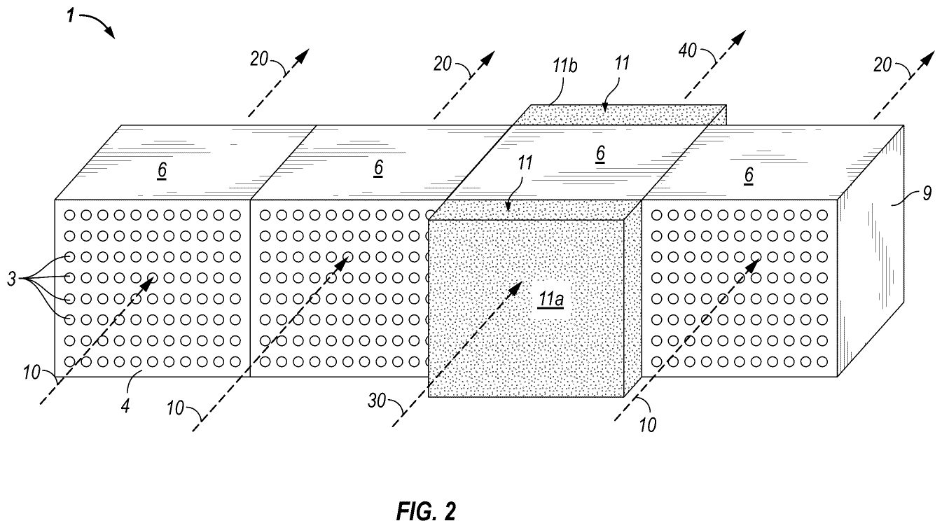

FIG. 2 a schematic representation of the DAC system of FIG. 1 in a second position;

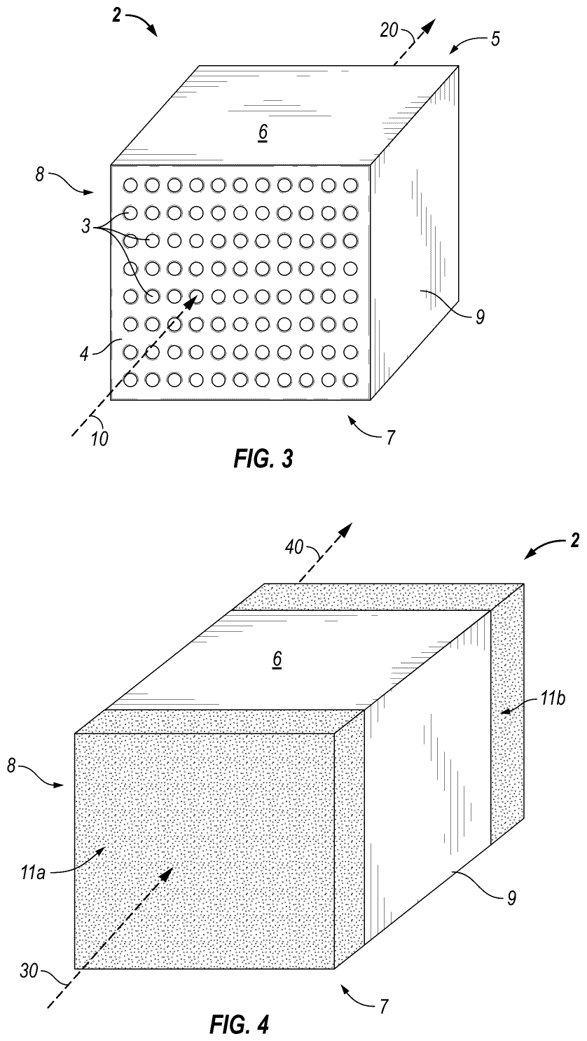

FIG. 3 an enlarged representation of a single monolith sorbent block as used in the DAC system of FIG. 1, when in adsorption phase; and

FIG. 4 an enlarged schematic representation of the monolith sorbent block of FIG. 3, when in desorption phase.

For the purpose of this description, same reference numbers refer to same or similar components or streams.

The DAC system of FIG. 1, generally referred to with reference number 1, comprises a plurality of adjacent porous monolith sorbent blocks 2. In the embodiment of FIG. 1 four monolith sorbent blocks 2 are shown (but any number of two and above can be applied). Each of the monolith sorbent blocks 2 defines substantially parallel internal channels 3 from a first (front) side 4 of the monolith sorbent block 2 to a second (rear) side 5 (not visible in FIG. 1 as it is on the rear side). In the embodiment of FIG. 1, the monolith sorbent blocks 2 have a rectangular shape and also have a top side 6, a bottom side 7 (not visible in FIG. 1), a left side 8 (not visible in FIG. 1) and a right side 9.

The adjacent porous monolith sorbent blocks 2 have a gas permeability (preferably between 10⁻⁶ and 10⁻⁸ m², more preferably between 5×10⁻⁶ and 5×10⁻⁷ m²) that is higher in the direction of the substantially parallel internal channels 3 from the first side 4 to the second sides 5 thereof than in the direction perpendicular to the parallel internal channels 3 (preferably between 10⁻¹⁰ and 10⁻¹⁴ m²). In other words, the sides 6-9 have a lower gas permeability than the channels 3, but are still porous (and hence not fully closed or sealed).

The DAC system 1 of FIG. 1 further comprises a sealer 11 for sealing the first side 4 and a second side of a specific monolith sorbent block 2 (in FIG. 1, the second as seen from the left). In the embodiment of FIG. 1, the sealer 11 is in the form of moveable doors 11a, 11b which can seal the first side 4 and second side 5 of a monolith sorbent block 2 during a desorption phase. Typically, to allow a desorption fluid 30 to pass through the channels 3 of a partly sealed monolith sorbent block 2 during a desorption phase, the sealer 11 may contain an opening or manifold or the like to enable supply of the desorption fluid. This opening or manifold (not shown in FIG. 1) can be part of the doors 11a, 11b of the sealer 11.

In the embodiment of FIG. 1, the moveable doors 11a, 11b form part of a moveable gantry (not shown) which can move from one monolith sorbent block 2 to another. In the embodiment shown in FIG. 1, the doors 11a, 11b of the moveable gantry only seal the first side 4 and second side 5 of a monolith sorbent block 2 during sealing of the specific monolith block 2, but not the other sides (i.e. top side 6, bottom side 7, left side 8 and right side 9). Hence, during sealing of a monolith sorbent block 2, the monolith sorbent block is not fully sealed (but only ‘partly sealed’) as some gas may still permeate through the sides 6-9.

The person skilled in the art will readily understand that, if desired, some of the sides 6-9 could be sealed as well during sealing, provided that not all of these sides 6-9 are fully sealed at the same time (thereby still obtaining a partly sealed monolith sorbent block 2). Preferably, during sealing, the sealer 11 leaves a space between two adjacent monolith sorbent blocks 2 unsealed during a desorption phase (the space being formed for example between a right side 9 of a first monolith block 2 and a left side 8 of a second, adjacent monolith sorbent block).

Preferably, the system 1 further comprises an upstream pressure reducer (not shown) which can reduce the pressure of a desorption fluid 30 before being passed through a partly sealed monolith sorbent block 2 and a downstream pressure reducer (not shown) which can reduce the pressure of a desorption fluid 30 downstream of the monolith sorbent block 2.

During use of the system of FIG. 1, a gaseous CO₂-containing stream 10, in particular ambient air, is passed—in an adsorption phase—via the first sides 4 and through the channels 3 of the plurality of adjacent porous monolith sorbent blocks 2 thereby adsorbing CO₂ from the CO₂-containing stream 10 onto (the inside of) the monolith sorbent blocks 2. From the second sides 5 (not shown) of the monolith sorbent blocks, a treated gaseous stream 20 having a reduced CO₂-concentration can exit the monolith sorbent blocks 2 and is removed therefrom.

Once a monolith sorbent block 2 has reached a pre-determined CO₂ saturation level, the first side 4 and second side 5 of a monolith sorbent block 2 are sealed by sealer 11. As mentioned before, the remainder of the monolith sorbent block 2 being sealed is not fully sealed thereby obtaining a partly sealed monolith sorbent block 2.

Then, the partly sealed monolith sorbent block 2 is desorbed in a desorption phase by passing a stream of a desorption fluid 30 through the partly sealed monolith sorbent block 2 thereby releasing CO₂ adsorbed to the partly sealed monolith sorbent block and thereby obtaining a CO₂-enriched stream 40 (and a CO₂-depleted monolith sorbent block). In the embodiment of FIG. 1, the desorption fluid 30 enters the channels 3 of the sealed monolith sorbent block 2, via an inlet (not shown) in the door 11a of the sealer 11.

The CO₂-enriched stream 40 is removed from the partly sealed monolith sorbent block 2 at an outlet (not shown) in the door at the second side 5 of the monolith sorbent block 2. Alternatively, the outlet may be in the door at the first side 4 (e.g. when there are multiple passes of the desorption fluid through the monolith sorbent block 2).

Subsequently, the sealing of the first side 4 and second side 5 of the partly sealed CO₂-depleted monolith sorbent block 2 is undone thereby obtaining an unsealed CO₂-depleted monolith sorbent block 2 which is ready again for a new adsorption phase. The passing of gaseous CO₂-containing stream 10 through the unsealed CO₂-depleted monolith sorbent block 2 is then recommenced.

FIG. 2 shows a schematic representation of the DAC system 1 of FIG. 1 in a second position. Where in FIG. 1 the monolith sorbent block 2 in the position second-from-the-left was sealed and being desorbed, in FIG. 2 the sealer 11 has moved one monolith sorbent block to the right and is sealing the first side 4 and second side 5 of an adjacent monolith sorbent block 2 (to the right, i.e. third-from-the-left) to allow desorption of said adjacent sorbent block 2. It goes without saying that the sealer 11 may seal more than one monolith sorbent blocks 2 at the same time to allow for simultaneous desorption of multiple monolith sorbent blocks 2.

FIG. 3 and FIG. 4 show enlarged representations of a single monolith sorbent block as used in the DAC system 1 of FIGS. 1 and 2, when in adsorption phase (FIG. 3) and in desorption phase (FIG. 4).

The person skilled in the art will readily understand that many modifications may be without departing from the scope of the invention.

The invention claimed is:

1. A process for capture of carbon dioxide (CO₂) from a gaseous CO₂-containing stream, the process at least comprising the steps of:
(a) providing a gaseous CO₂-containing stream, in particular ambient air;
(b) passing the gaseous CO₂-containing stream through a plurality of adjacent porous monolith sorbent blocks thereby adsorbing CO2 from the CO2-containing stream onto the monolith sorbent blocks, wherein each of the monolith sorbent blocks defines substantially parallel internal channels from a first side of the monolith sorbent block that during a CO2-adsorption phase can receive the gaseous CO2-containing stream to a second side from which a treated gaseous stream (20) having a reduced CO2-concentration can exit the monolith sorbent block;
(c) removing a treated stream from the second side of the monolith sorbent blocks having a reduced CO2-concentration compared to the gaseous CO2-containing stream provided in step (a);
(d) sealing the first and second sides of a monolith sorbent block once it has reached a pre-determined CO2 saturation level, wherein during the sealing of the first and second sides of the monolith sorbent block the remainder of the monolith sorbent block is not fully sealed thereby obtaining a partly sealed monolith sorbent block;
(e) desorbing the partly sealed monolith sorbent block by passing a stream of a desorption fluid through the partly sealed monolith sorbent block thereby releasing CO2 adsorbed to the partly sealed monolith sorbent block and thereby obtaining a CO2-enriched stream and a partly sealed CO2-depleted monolith sorbent block;
(f) removing the CO2-enriched stream obtained in step (e) from the partly sealed monolith sorbent block;
(g) undoing the sealing of the first and second sides of the partly sealed CO2-depleted monolith sorbent block thereby obtaining an unsealed CO2-depleted monolith sorbent block; and
(h) recommencing the passing of gaseous CO2-containing stream 4 through the unsealed CO2-depleted monolith sorbent block obtained in step (g).

2. The process according to claim 1, wherein the plurality of adjacent porous monolith sorbent blocks have a gas permeability that is higher in the direction of the substantially parallel internal channels from the first side to the second sides thereof than in the direction perpendicular to the parallel internal channels.

3. The process according to claim 1, wherein the gaseous CO2-containing stream being passed through the channels of the plurality of adjacent porous monolith sorbent blocks has a velocity of greater than 1.0 m/s.

4. The process according to claim 1, wherein the first and second sides of a monolith sorbent block are sealed in step (d) by moveable doors.

5. The process according to claim 4, wherein the moveable doors form part of a moveable gantry, wherein the doors of the moveable gantry only seal the first and second sides of a monolith sorbent block.

6. The process according to claim 1, wherein a space between two adjacent porous monolith sorbent blocks is left unsealed.

7. The process according to claim 1, wherein the stream of desorption fluid in step (e) has a pressure of between 0.50-1.50 bara.

8. The process according to claim 1, wherein the desorption fluid being passed through the channels of the plurality of adjacent porous monolith sorbent blocks has a velocity of below 0.5 m/s.

9. The process according to claim 1, wherein the desorption fluid is, before passing through the partly sealed monolith sorbent block reduced in pressure over a pressure reducer upstream of the monolith sorbent block and further reduced in pressure over a pressure reducer downstream of the monolith sorbent block,
wherein at least one of the pressure reducers is a valve and wherein a predetermined pressure in the monolith sorbent block is maintained by a controller acting on the at least one valve.

10. A system for capture of carbon dioxide (CO2) from a gaseous CO2-containing stream, the system at least comprising:
a plurality of adjacent porous monolith sorbent blocks, wherein each of the monolith sorbent blocks defines substantially parallel internal channels from a first side of the monolith sorbent block that during a CO2-adsorption phase can receive the gaseous CO2-containing stream to a second side from which a treated gaseous stream (20) having a reduced CO2-concentration can exit the monolith sorbent block; and
a sealer for sealing the first and second sides of a monolith sorbent block;
wherein during the sealing of the first and second sides of the monolith sorbent block the remainder of the monolith sorbent block is not fully sealed thereby obtaining a partly sealed monolith block.

11. The system according to claim 10, further comprising moveable doors which can seal the first and second sides of a monolith sorbent block during a desorption phase.

12. The system according to claim 11, wherein the moveable doors form part of a moveable gantry, wherein the doors of the moveable gantry can seal only the first and second sides of a monolith sorbent block.

13. The system according to claim 10, wherein the sealer can leave a space between two adjacent monolith sorbent blocks unsealed during a desorption phase.

14. The system according to claim 10, further comprising:
an upstream pressure reducer which can reduce the pressure of a desorption fluid before being passed through a partly sealed monolith sorbent block;
a downstream pressure reducer which can reduce the pressure of a desorption fluid downstream of the monolith sorbent block; and
a pressure controller which can act on at least one of the upstream and downstream pressure reducers to maintain a predetermined pressure in the monolith sorbent block.

15. The process according to claim 7, wherein the stream of desorption fluid in step (e) has a pressure of between 0.90-1.10 bara.

16. The process according to claim 7, wherein the stream of desorption fluid in step (e) has a pressure of between 0.95-1.05 bara.
